(19) United States
(12) Patent Application Publication
(10) Pub. No.: US 2012/0075666 A1
(43) Pub. Date: Mar. 29, 2012

(54) IMAGE PROCESSING APPARATUS, DATA PROCESSING METHOD OF IMAGE PROCESSING APPARATUS, AND STORAGE MEDIUM

(75) Inventor: Yuichiro Shibuya, Kawasaki-shi (JP)

(73) Assignee: CANON KABUSHIKI KAISHA, Tokyo (JP)

(21) Appl. No.: 13/233,322

(22) Filed: Sep. 15, 2011

(30) Foreign Application Priority Data
Sep. 27, 2010 (JP) 2010-214782

(51) Int. Cl. G06F 15/00

(52) U.S. Cl. 358/1.15

(57) ABSTRACT

In an image processing apparatus that generates image data from drawing information, compresses the image data and stores the data in a memory, it is determined whether the data amount of the image data exceeds an amount of a difference between an amount of space securable in the memory and a first threshold determined from the amount of the memory available in the memory. If a CPU determines that the amount of the image data exceeds the amount of the difference from the first threshold, the CPU performs a fake compression processing for compressing the image data by a compression unit without storing the image data in the memory. If the CPU determines that the amount of the image data does not exceed the amount of the difference from the first threshold, the CPU performs a compression processing for compressing the image data by a compression unit.

### BACKGROUND OF THE INVENTION

1. Field of the Invention

The present invention relates to an image processing apparatus for receiving and processing print information from a host computer, a data processing method of the image processing apparatus, and a storage medium.

2. Description of the Related Art

In recent years, information processing systems in which a color image processing apparatus and a plurality of host computers can communicate with each other have been generalized and widely used. In such a circumstance, many electronic documents are generated in the information processing systems, and requests made to the color image processing apparatuses concerning document output tend to increase. To cope with the increasing demands, a high-speed and inexpensive color image processing apparatus is desired.

In a conventional printing system, generally, a page description language (PDL) transmitted from a host computer is interpreted, a display list (DL) that is an intermediate language is generated, and raster image conversion (rendering) is performed using the DL.

In the processing, the size of the PDL data is not limited. Accordingly, sometimes, the size of the DL generated from the PDL data is very large. Further, if the DL is complicated and the size is large, a work area used by a renderer for rendering the DL also increases in size.

However, the amount of the memory mounted to the image processing apparatus has a limit, and also has a limit in costs. Due to the limitations, the many memory amounts are not sufficient for storing the DL. Accordingly, the area for storing the DL and the size of the work area the renderer can use are limited. As a result, the DL of a predetermined size or more cannot be processed.

To prevent the limitations, processing called fallback is performed. In the fallback processing, if a size of a DL or a work area for processing the DL exceeds a predetermined size, the DL already generated by that time is rendered once to generate a raster image, and the DL generated by that time is cleared once.

Then, the raster image is added to a part of the DL again as a background image in the drawing region. Generally, the background image is compressed. As a result, the size of the added DL is smaller than the original DL. By generating the remaining DL in the free space, within the limited memory space, the DL of the large size can be processed.

Further, when the rendering processing is completed in the fallback processing, the work area for the renderer is also cleared. As a result, the size limitation in the work area can also be avoided, and the low-cost image processing apparatus can be provided.

Meanwhile, as described above, the raster image generated in the fallback processing is compressed and added to the DL list, and it is necessary to compress the image generated in the processing to a predetermined size.

Especially, in a color image process, the size of the raster image generated in the rendering is very large, and often the image cannot be compressed within the predetermined size in lossless compression. Therefore, generally, lossy compression is used.

However, in the lossy compression, a quality of the compressed image deteriorates. In order to minimize the image deterioration, by gradually changing the compression rate of the rendered image from a low compression ratio to a high compression ratio (from compression in which the image deterioration is small to compression in which the image deterioration is large), the processing is repeated a plurality of times until the size of the compressed image is reduced to the predetermined size. Thus, the image is compressed at the lowest compression ratio at which the image is within the predetermined size. Thus, the lowest image deterioration can be achieved. In the conventional image processing apparatuses, a threshold for determining the deterioration state in the raster image information at the compression is specified, and whether the specified threshold is exceeded is determined.

Thus, the user can select whether to print the print output containing the largely deteriorated compressed image. With the above-described processing, the print output which the user does not want to implement is prevented, and the usability is increased (for example, see Japanese Patent Application Laid-Open No. 2004-152141).

Further, in the conventional image processing apparatuses, by performing fake compression processing for calculating the compression ratio without performing the memory output in advance, the compression processing of the raster image information is performed after the compression ratio is determined. Thus, a case is avoided in which the compression processing of the raster image information waits until the memory space becomes available.

In the conventional image processing apparatuses, regardless of the memory usage, the fallback processing is uniformly performed. Accordingly, in the image processing apparatus that does not perform the fake compression, if the free memory is insufficient, the apparatus waits until available space appears. In the image processing apparatus that performs the fake compression, even if the memory amount is sufficient, the fake compression is performed unnecessarily.

### SUMMARY OF THE INVENTION

The present invention is directed to reducing compression processing time after waiting for available memory is finished, to the minimum even if a compression ratio is high in performing fallback processing within a limited memory amount. Further, the present invention is directed to avoiding unnecessary fake compression processing and reducing the compression processing time if the available memory amount is sufficient in performing the fallback processing within the limited memory amount.

According to an aspect of the present invention, an image processing apparatus includes a generation unit configured to generate image data from drawing information, a compression unit configured to compress the image data, a storage unit configured to store the drawing information, the image data, and background compressed data generated by the compression unit compressing the image data as drawing information, a determination unit configured to determine whether a data amount of the image data exceeds an amount of a difference between an amount of space securable in the storage unit and a first threshold determined from the amount of the memory available in the storage unit, and a control unit configured to perform control such that if the determination unit determines that the amount of the image data exceeds the amount of the difference from the first threshold, without storing the image data in the storage unit, a fake compression processing for compressing the image data is performed by the compression unit, and if the determination unit determines that the amount of the image data does not exceed the amount of the difference from the first threshold, a compression processing for compressing the image data is performed by the compression unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing apparatus.

FIG. 2 is a block diagram illustrating a detailed configuration of the controller illustrated in FIG. 1.

FIG. 3 is a flowchart illustrating a control procedure of the image processing apparatus.

FIG. 4 is a flowchart illustrating a control procedure of the image processing apparatus.

FIG. 5 illustrates the usage of a first memory in the memory illustrated in FIG. 1.

FIG. 6 is a flowchart illustrating a control procedure of the image processing apparatus.

FIG. 7 is a flowchart illustrating a control procedure of the image processing apparatus.

FIG. 8 is a flowchart illustrating a control procedure of the image processing apparatus.

FIG. 9 illustrates the usage of a second memory in the memory illustrated in FIG. 1.

FIG. 10 is a flowchart illustrating a control procedure of the image processing apparatus.

FIG. 11 illustrates the usage of a third memory in the memory illustrated in FIG. 1.

FIG. 12 is a flowchart illustrating a control procedure of the image processing apparatus.

### DESCRIPTION OF THE EMBODIMENTS

Various exemplary embodiments, features, and aspects of the invention will be described in detail below with reference to the drawings.

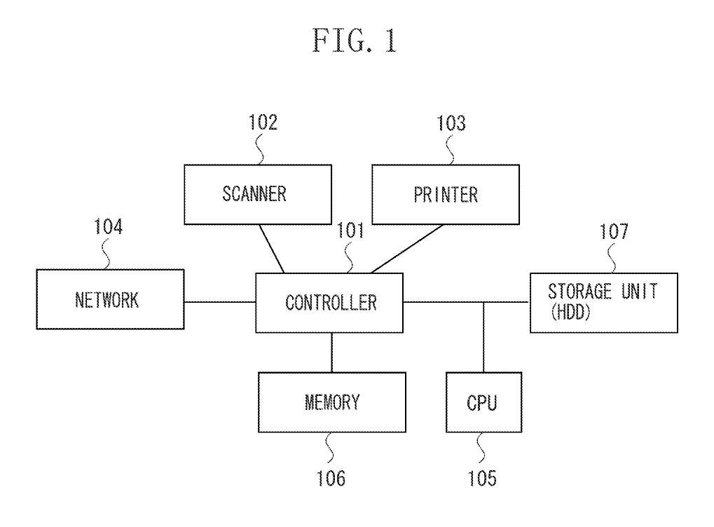

FIG. 1 is a block diagram illustrating a configuration of an image processing apparatus according to a first exemplary embodiment. In the exemplary embodiment, as the image processing apparatus, a digital multi-functional peripheral system (hereinafter, referred to as MFP) for performing scanning, printing, and copying is described.

In FIG. 1, a controller 101 is connected to a scanner 102 that serves as an image input device, a printer 103 that serves as an image output device, and a network 104, for example, a local area network (LAN) or a public line (wide area network (WAN)). With the configuration, input or output of image information or device information, and image rasterization of PDL data is performed. The printer 103 includes an engine unit (not shown) for outputting an image on a conveyed recording paper. The engine unit includes a sensor for detecting paper-out, toner-out, and the like. A central processing unit (CPU) 105 receives the sensor information via the controller 101, and determines whether the engine unit can currently output an image.

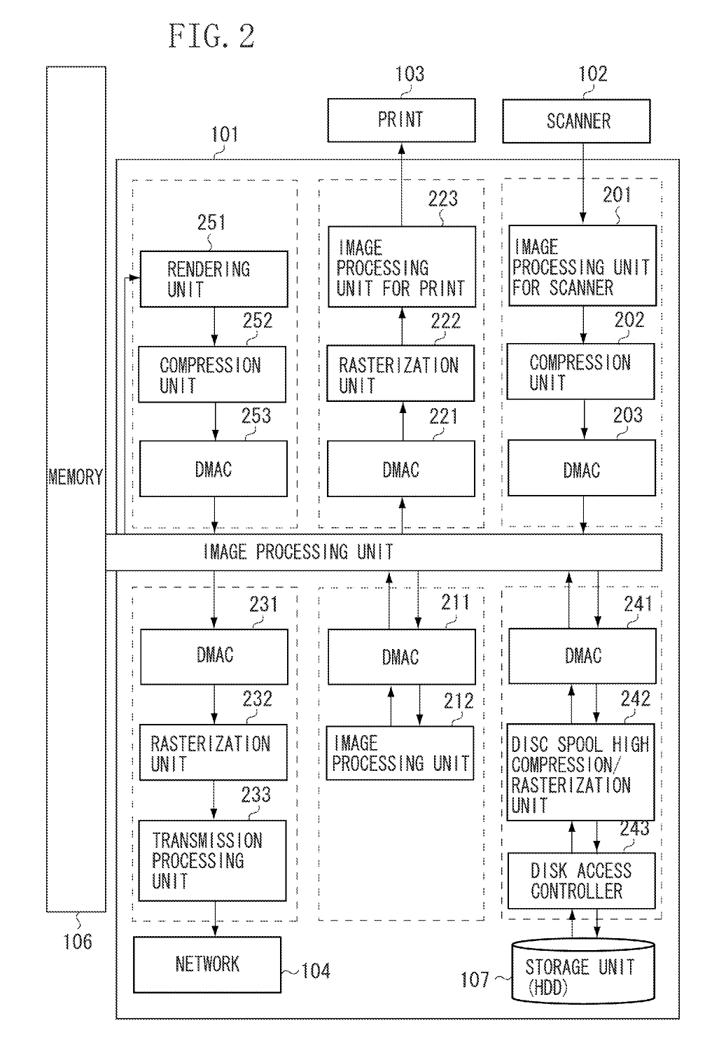

The CPU 105 serves as a processor for performing overall control of the system including devices connected to a bus. A memory 106 is a system work memory for operating the CPU 105. The memory 106 serves as an image memory for temporarily storing image data. The memory 106 includes a volatile memory such as a random access memory (RAM). A storage unit 107 is a hard disk drive (HDD). The storage unit 107 stores system software that can be executed by the CPU 105, and image data. FIG. 2 is a block diagram illustrating a detailed configuration of the controller 101 illustrated in FIG. 1. Hereinafter, a configuration for reading scan data is described as an example.

In FIG. 2, the controller 101 that receives read image data of three colors of red, green, and blue (RGB) from the scanner 102 performs image processing such as shading processing and filter processing in an image processing unit 201 for scanner. An image compression processing is performed to the image-processed data in a compression unit 202. The compressed data is stored in the memory 106 via a direct memory access controller (DMAC) 203.

The memory 106 is used as a memory for storing drawing information, the image data, and background compression data generated by a compression unit 252 compressing image data rasterized by a rendering unit 251 as drawing information.

In printing the scan data, the compressed data stored in the memory 106 is input to an image processing unit 212 via a DMAC 211, and converted into cyan, magenta, yellow, and black (CMYK) color space. After the processing, color processing for adjustment, for example, density adjustment and printer gamma correction are performed to the values of CMYK. The processed data is stored in the memory 106 again via the DMAC 211.

Then, in order to perform image processing for printing, via a DMAC 221, the compressed data stored in the memory 106 is read, and the data is rasterized to raster image data in a rasterization unit 222. The raster CMYK image data is input into an image processing unit 223 for printing. In the image processing unit 223, an area gradation processing by a dither method or an error diffusion method is performed, and the data is output to the printer 103. In transmitting the scan data to the network, the compressed data stored in the memory 106 is input to the image processing unit 212 via the DMAC 211, and color conversion is performed.

Specifically, after a display gamma adjustment, a sheet ground color adjustment, and the like are performed, the data is converted into a YCbCr (luminance, blue difference, and red difference) color space. The data is stored in the memory 106 via the DMAC 211 again. After the processing, in order to perform image processing for transmission, via a DMAC 231, the compressed data stored in the memory 106 is read, and the data is rasterized to raster image data in a rasterization unit 232. To raster YCbCr image data, in a transmission processing unit 233, in a case of color image transmission, a Joint Photographic Experts Group (JPEG) compression processing is performed. In a case of monochrome binarized image transmission, a binarization processing is performed to the Y data and further a Joint Bi-level Image Experts Group (JBIG) compression processing, or the like is performed. The data is output to the network 104.

In storing the scan data, the compressed data stored in the memory 106 is input to a disc spool high compression/rasterization unit 242 via a DMAC 241. In the disc spool high compression/rasterization unit 242, the writing speed to the storage unit 107 in the HDD is slow as compared to the memory 106. Accordingly, the JPEG compression that performs the compression at a higher ratio is performed. After the processing, via a disk access controller 243, the compressed data is stored in the storage unit 107 in the HDD. If the stored data is rasterized again in the memory 106, an inverse processing is to be performed. Hereinafter, writing of the PDL data in the memory 106 is described.

While not illustrated in FIG. 2, the PDL data transmitted from the network 104 in FIG. 1 is interpreted in the CPU 105, and a display list is output to the memory 106. After that, the display list stored in the memory 106 is rendered into raster RGB image data in the rendering unit 251, and image compression processing is performed in the compression unit 252. The compressed data is stored in the memory 106 via a DMAC 253. Printing, transmission to the network, and storing of the PDL image data can be performed by processing similar to the scan data processing.

The compression unit 252 performs lossy compression to the raster image, and stores the image in the memory 106 via the DMAC 253. The compression unit 252 according to the exemplary embodiment uses the JPEG compression. By changing a Q table to be used in the JPEG compression, the compression ratio of the image can be changed. At a high compression rate, a quality of the image deteriorates largely. In the exemplary embodiment, the JPEG compression is used as the lossy compression. However, as long as the compression ratio can be changed, any lossy compression method can be used in the present invention. In compressing a raster image generated in rendering processing described below, for example, six types of the Q tables to be set for the JPEG processing in the compression unit 252 are provided.

Each Q table has identifiers of one to six, and the identifiers are referred to as Q-table IDs for convenience. Each Q table is set such that as the Q-table ID increases in a number, the compression ratio increases. Accordingly, if a Q table having a large Q-table ID is used, the image quality deteriorates largely. In the exemplary embodiment, a number of the types of the Q-tables are six. However, the number of the types is not limited to that. The data processing of writing the PDL data in the memory in the compression unit is a feature in the present invention. Hereinafter, the processing of writing the PDL data is described in detail.

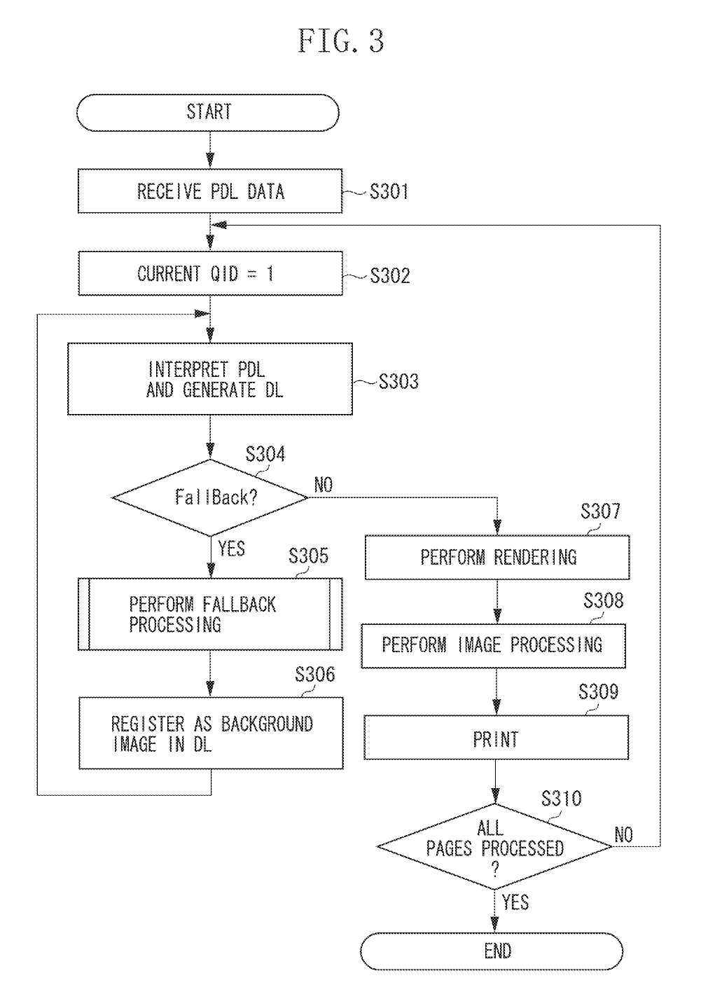

FIG. 3 is a flowchart illustrating a control procedure of the image processing apparatus according to the exemplary embodiment. In the exemplary embodiment, the procedure corresponds to print processing of the PDL data to be processed by the CPU 105 when the PDL data is received. Each step is implemented by the CPU 105 loading a control program in the memory 106.

In step S301, if the controller 101 receives PDL data from the network 104, the processing proceeds to step S302. In step S302, the CPU 105 sets a variable current QID indicating a Q-table ID currently set, to “1”. Then, the processing proceeds to step S303.

In step S303, the CPU 105 generates (creates) a display list (DL) in the memory 106 while performing an analyzing processing of the PDL data. Then, the processing proceeds to step S304. In the generation of the DL in step S303, normally, the DL of one page is generated.

In the processing, the size of a local memory for the rendering unit 251 and the size of the table for the work are regularly monitored. If the size of the DL being generated exceeds the size of the local memory, or if the size of the table for the work used in rendering the DL being generated exceeds the table size mounted to the rendering unit 251, the fallback occurs.

In such a case, the CPU 105 sets a fallback flag, and the processing proceeds to step S304. In step S304, the CPU 105 checks the fallback flag, and checks whether the fallback is occurring. If the CPU 105 determines that the fallback is occurring (YES in step S304), the processing proceeds to step S305. In step S305, the CPU 105 performs the fallback processing, and a compressed image is stored in the memory 106. The processing will be described in detail below. The CPU 105 registers the compressed image as a background image in the DL. Then, the processing returns to step S303, and the CPU 105 continues the analysis of the PDL data and generation of the DL. If the CPU 105 determines that the fallback is not occurring (NO in step S304), the processing proceeds to rendering processing in step S307.

In the rendering processing in step S307, the CPU 105 renders the generated DL using the rendering unit 251, and generates a raster image. Then, the CPU 105 generates a compressed image from the raster image using the compression unit 252, and stores the image in the memory 106 via the DMAC 253.

After the rendering processing in step S307, the processing proceeds to step S308. In step S308, the CPU 105 transfers the compressed image stored in the memory 106 to the DMAC 221. While decompressing the transferred compressed image into a raster image using the rasterization unit 222, the CPU 105 performs an image processing using the image processing unit 223 for printer, and the processing proceeds to step S309. In step S309, the CPU 105 transfers the raster image to which the image processing is performed in step S308 to the printer 103, and performs printing on paper. Then, the processing proceeds to step S310.

In step S310, the CPU 105 determines whether the processing of the all pages in the PDL data received in step S301 is completed. If the CPU 105 determines that the processing of the all pages is completed (YES in step S310), the CPU 105 ends the print processing of the DL data.

If the CPU 105 determines that the PDL data to be processed still remains (NO in step S310), the processing returns to step S302. In step S302, the CPU 105 initializes the current QID to “1”, and continues the analysis of the PDL data and the DL generation processing (DL creation processing).

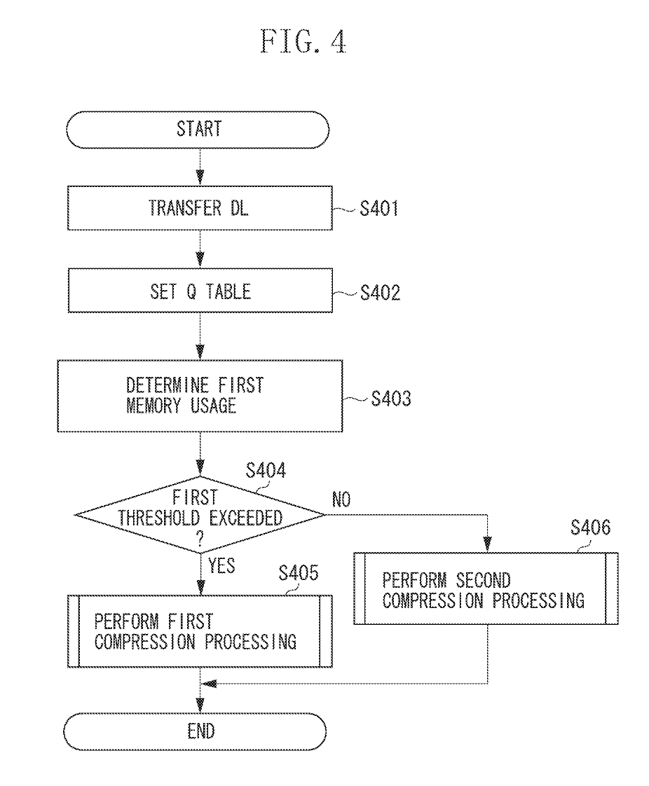

FIG. 4 is a flowchart illustrating a control procedure of the image processing apparatus according to the exemplary embodiment. The example is fallback processing. The processing corresponds to the detailed procedure of step S305 illustrated in FIG. 3. Each step is implemented by the CPU 105 loading a control program in the memory 106.

When the above-described processing in step S305 of FIG. 3 is carried out, the processing starts. In step S303, the CPU 105 transfers the DL generated in the memory 106 to the local memory in the rendering unit 251 (step S401). Then, the processing proceeds to step S402. In step S402, the CPU 105 sets the Q table corresponding to the Q-table ID set to the variable current QID, to the compression unit 252. In step S403, the CPU 105 determines the memory usage status. The determination of NO in step S404 includes a case in which, for example, the memory region available at the time of the start of the processing is used by another processing, for example, in response to a multi-functional processing request.

In the exemplary embodiment, the CPU 105 determines whether the amount of the image data exceeds an amount of a difference between an amount of space securable in the memory 106 and a first threshold determined from the amount of the memory available in the storage unit. If the CPU 105 determines that the amount of the image data exceeds the amount of the difference from the first threshold (YES in step S404), the CPU 105 performs a fake compression processing for compressing the image data with the compression unit 252 without storing the background compressed data in the storage unit 106. Thus, by utilizing the time waiting for available memory, the CPU 105 can generate background compressed data that is compressed to a size which the memory 106 can store.

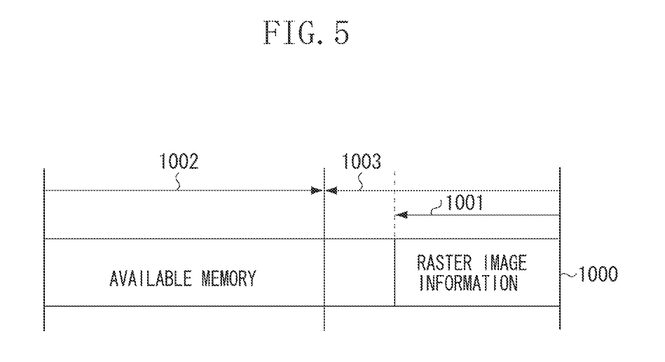

If the CPU 105 determines that the amount of the image data does not exceed the amount of the difference from the first threshold (NO in step S404), the CPU 105 stores the background compressed data in the memory 106 without performing the fake compression processing with the compression unit 252. Thus, if the available memory can be provided sufficiently in the memory 106, the unnecessary fake compression is not performed, and as a result, the compression processing time can be reduced. FIG. 5 illustrates usage of a first memory in the memory 106 illustrated in FIG. 1.

In FIG. 5, reference numeral 1002 denotes an amount of the first threshold. If the CPU 105 determines that an amount 1001 of the raster image information is larger than a difference 1003 between the whole memory amount sufficient for storing the raster image information and the amount of the first threshold, the CPU 105 proceeds to step S405 in FIG. 4 and performs a first compression processing.

If the CPU 105 determines that the amount 1001 of the raster image information is smaller than the difference 1003 between the whole memory amount sufficient for storing the raster image information and the amount of the first threshold, the CPU 105 proceeds to step S406 and performs second compression processing. The processing will be described in detail below. In the first compression processing and the second compression processing, the DL generated in the memory 106 is converted into a compressed image, and the fallback processing ends.

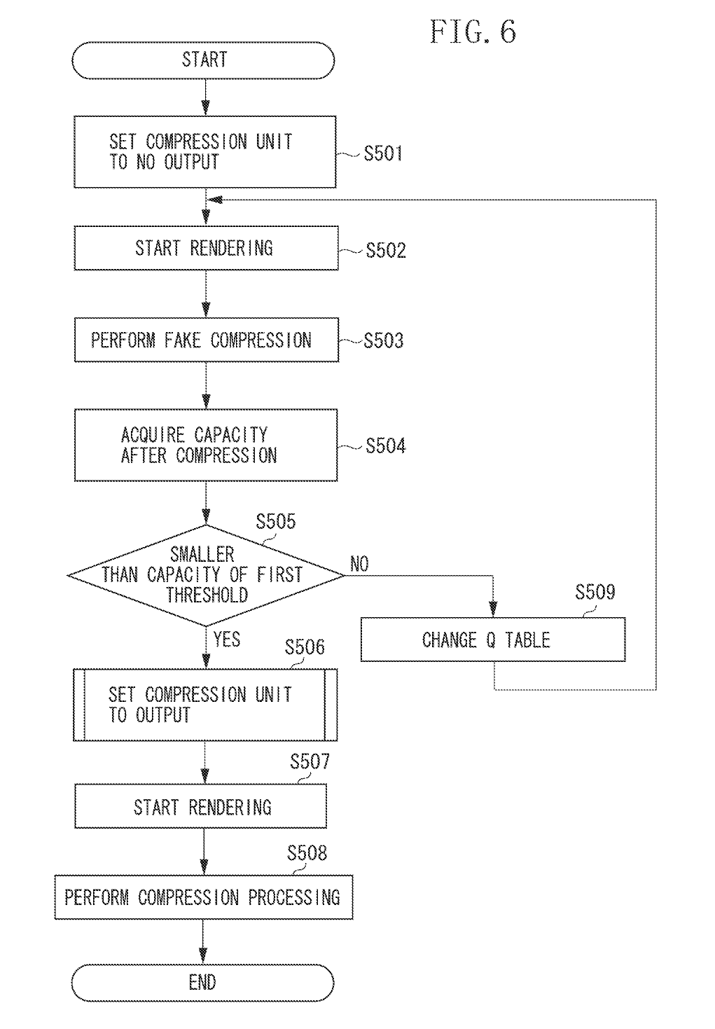

FIG. 6 is a flowchart illustrating a control procedure of the image processing apparatus according to the exemplary embodiment. The example corresponds to a detailed procedure of the first compression processing. Hereinafter, the detailed procedure of step S405 illustrated in FIG. 4 is described, in which the DL is rendered, the generated raster image is compressed and stored in the memory. Each step is implemented by the CPU 105 loading a control program in the memory 106.

When the above-described processing is carried out in step S405 illustrated in FIG. 4, the processing starts. In step S501, the CPU 105 sets “no memory output” to the compression unit 252. In step S502, the CPU 105 performs various initialization processing such as setting of the register in the rendering unit 251. Then, the CPU 105 transmits a signal for starting a rendering processing, and starts the rendering processing of the DL.

In step S503, the CPU 105 transfers the raster image generated in step S502 to the compression unit 252, and performs a JPEG compression using the Q table set in step S402. Since the CPU 105 has set “no output” to the compression unit, the compression unit does not perform output to the memory.

In step S504, the CPU 105 refers to an output counter for the JPEG compression in the compression unit 252, and acquires the amount of the compressed raster image. In step S505, the CPU 105 determines whether the amount is less than the amount of the first threshold. If the CPU 105 determines that the amount is less than the amount of the first threshold (YES in step S505), the processing proceeds to step S506. In step S506, the CPU 105 sets “no memory output” to the compression unit 252. In step S507, the CPU 105 performs the various initialization processing such as the setting of the register in the rendering unit 251 again. Then, the CPU 105 transmits a signal for starting the rendering processing, and starts the rendering processing. In step S508, the CPU 105 transfers the raster image generated in step S507 to the compression unit 252, and performs the JPEG compression using the set Q table.

In step S505, if it the CPU 105 determines that the amount of the compressed raster image is greater than the amount of the first threshold (NO in step S509), the processing proceeds to step S509. In step S509, the CPU 105 increments the value of the variable current QID. Then, the processing returns to step S502. The CPU 105 resets the Q table corresponding to the Q-table ID set to the variable current QID, to the compression unit 252, and restarts the rendering processing.

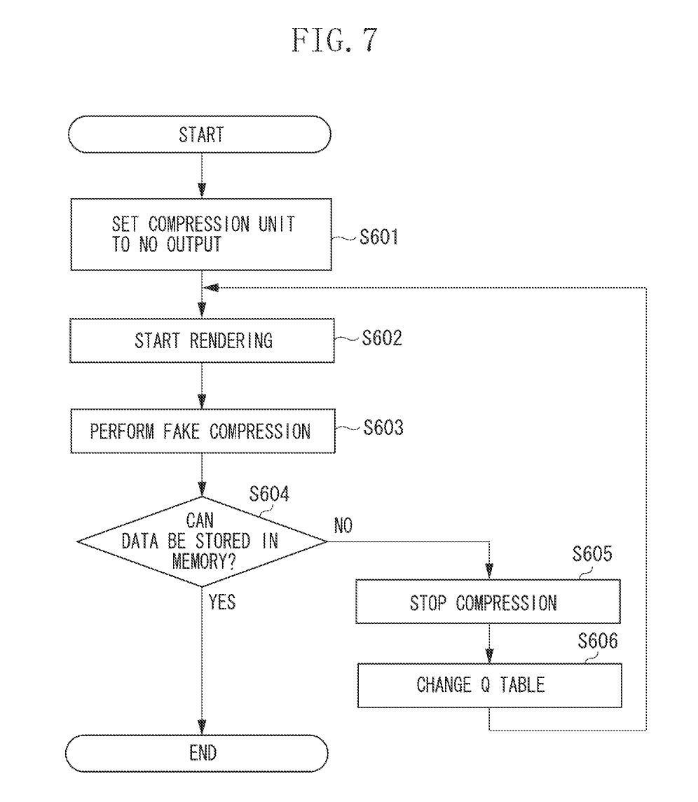

FIG. 7 is a flowchart illustrating a control procedure of the image processing apparatus according to the exemplary embodiment. The example corresponds to a detailed procedure of the second compression processing. FIG. 7 is a flowchart illustrating the second compression processing. Hereinafter, the detailed procedure of step S406 illustrated in FIG. 4 is described, in which the DL is rendered, the generated raster image is compressed and stored in the memory. Each step is implemented by the CPU 105 loading a control program in the memory 106. When the above-described processing in step S406 illustrated in FIG. 4 is carried out, the processing starts. In step S601, the CPU 105 sets “memory output” to the compression unit 252. In step S602, the CPU 105 performs various initialization processing such as setting of the register in the rendering unit 251. Then, the CPU 105 transmits a signal for starting rendering processing of the DL, and starts the rendering processing.

In step S603, the CPU 105 transfers the raster image generated in step S502 to the compression unit 252, and performs the JPEG compression using the set Q table. Since the CPU 105 has set “output” to the compression unit in step S602, the compression unit 252 performs the output to the memory via the DMAC 253.

In step S604, the CPU 105 determines whether the output from the output counter for the JPEG compression in the compression unit 252 is completed at an amount less than the amount of the first threshold. If the CPU 105 determines that the output is completed at the amount less than the first threshold (YES in step S604), in other words, the CPU 105 determines that it is possible to store the data in the memory, the compressed image is normally stored in the memory, and the second compression processing ends.

On the other hand, in step S604, if the CPU 105 determines that the output counter for the JPEG compression reaches the amount of the first threshold (NO in step S604), in other words, the CPU 105 determines that it is not possible to store the data in the memory, the processing proceeds to step S605. In step S605, the compression unit 252 stops the compression processing. The CPU 105 discards the remaining compressed image stored in the memory, and the processing proceeds to step S606. In step S606, the CPU 105 increments the value of the variable current QID, and the processing returns to step S602. The CPU 105 resets the Q table corresponding to the Q-table ID set to the variable current QID, to the compression unit 252, and restarts the rendering processing.

In the image processing apparatus in the first exemplary embodiment, in the case where the available memory is insufficient, using the time for waiting for available space in the memory, the fake compression processing is performed. Accordingly, the compression processing time after the available memory is provided can be reduced to the minimum even if the compression ratio is high. In the case where the available memory is sufficient, the unnecessary fake compression can be skipped. Accordingly, the compression processing time can be reduced.

Hereinafter, a second exemplary embodiment is described. In the image processing apparatus described in the first exemplary embodiment, the usage of the memory is determined from only the amount of the available memory. However, an amount of a compressed image expected to immediately become available can be used similarly to the available memory. The description in the exemplary embodiment is similar to that in FIG. 3 in the above-described first exemplary embodiment. Accordingly, only different parts will be described below. Specifically, the CPU 105 determines whether the data amount of the background compressed data exceeds an amount of a difference between an amount of space securable in the memory 106 and the first threshold determined from the amount of the memory available in the memory 106. If the CPU 105 determines that the amount of the background compressed data exceeds the amount of the difference from the first threshold, the CPU 105 performs the fake compression processing for compressing the image data with the compression unit 252 without storing the background compressed data in the memory 106. If the CPU 105 determines that the amount of the background compressed data does not exceed the amount of the difference from the first threshold, the CPU 105 performs control of storing the background compressed data in the memory 106 without performing the fake compression processing with the compression unit 252.

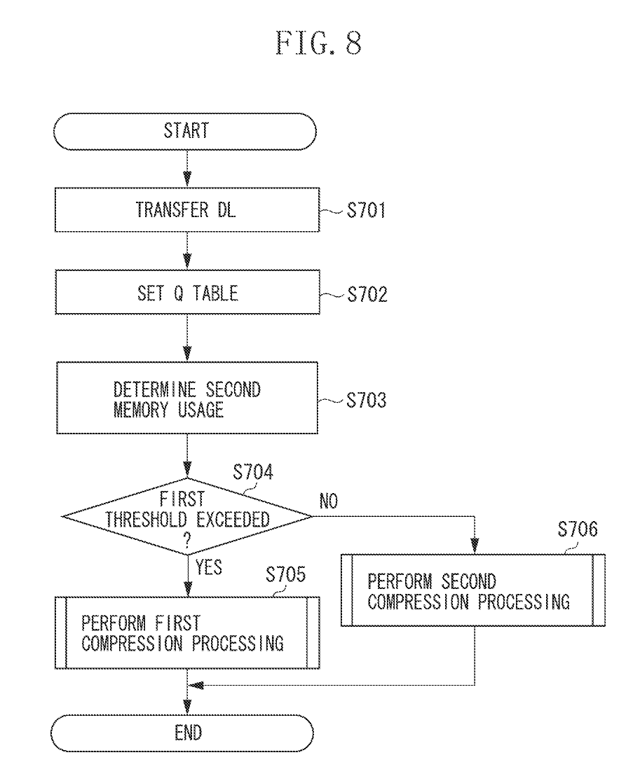

FIG. 8 is a flowchart illustrating a control procedure of the image processing apparatus according to the exemplary embodiment. The processing is a fallback processing, and corresponds to the detailed procedure of step S305 illustrated in FIG. 3. Each step is implemented by the CPU 105 loading a control program in the memory 106.

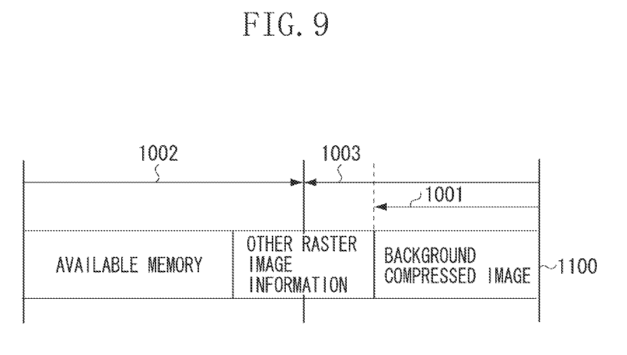

When the above-described processing in step S305 illustrated in FIG. 3 is carried out, the processing starts. In step S701, the CPU 105 transfers the DL generated in the memory 106 to the local memory in the rendering unit 251. In step S702, the CPU 105 sets the Q table corresponding to the Q-table ID set to the variable current QID, to the compression unit 252. In step S703, the CPU 105 determines the memory usage status. FIG. 9 illustrates the usage of the second memory in the memory 106 illustrated in FIG. 1. In FIG. 9, reference numeral 1102 denotes an amount of the first threshold.

In step S704, if the CPU 105 determines that an amount 1101 of the background image in the fallback is greater than a difference 1103 between the whole memory amount sufficient for storing the raster image information and the amount of the first threshold (YES in step S704), the processing proceeds to step S705. In step S705, the CPU 105 performs the first compression processing.

On the other hand, in step S704, if the CPU 105 determines that the amount 1101 of the background image in the fallback is equal to or less than the difference 1103 between the whole memory amount sufficient for storing the raster image information and the amount of the first threshold (NO in step S704), the processing proceeds to step S706. In step S706, the CPU 105 performs the second compression processing. In the first compression processing and the second compression processing, the DL generated in the memory 106 is converted into a compressed image, and the fallback processing ends. In the image processing apparatus in the second exemplary embodiment, by similarly dealing with the amount of the compressed image expected to immediately become available, as the available memory, the memory usage status can be determined more appropriately. Thus, in the case where waiting for available memory is likely to occur, the fake compression processing is performed. Accordingly, even if the compression ratio is high, the compression processing time after the memory which is waited for becomes available can be reduced to the minimum. In the case where waiting for the available memory is not likely to occur, the unnecessary fake compression can be skipped. Accordingly, the compression processing time can be reduced.

Hereinafter, a third exemplary embodiment is described. In the image processing apparatus described in the second exemplary embodiment, the amount of the compressed image expected to immediately become available is used similarly to the available memory. Alternatively, the compressed image expected to immediately become available can be used exclusively as a compressed image waiting for printing.

The description in the exemplary embodiment is similar to that in FIG. 3 in the above-described first exemplary embodiment. Accordingly, only different parts will be described below. Specifically, the CPU 105 serves as a first determination unit, a second determination unit, and a control unit. The CPU 105 determines whether a data amount of the background compressed data exceeds an amount of a difference between an amount of space securable in the memory 106 and a first threshold determined from the amount of the memory available in the memory 106. Further, the CPU 105 determines whether a data amount of the sum of the background compressed data and the compressed data waiting for printing exceeds a second threshold determined from the memory amount available in the memory 106.

If the CPU determines that the data amount of the background compressed data exceeds the amount of the difference, or the data amount of the background compressed data does not exceed the amount of the difference, further performs the following determination. If the CPU 105 determines that the data amount of the sum of the background compressed data and the compressed data waiting for printing exceeds the second threshold, the CPU 105 performs the following processing without storing the background compressed data in the memory 106. The CPU 105 performs the fake compression processing for compressing the image data with the compression unit 252. If the CPU 105 determines that the data amount of the background compressed data does not exceed the amount of the difference, and the data amount of the sum of the background compressed data and the compressed data waiting for printing does not exceed the second threshold, the CPU 105 performs the following processing. The CPU 105 stores the background compressed data in the memory 106 without performing the fake compression processing with the compression unit 252.

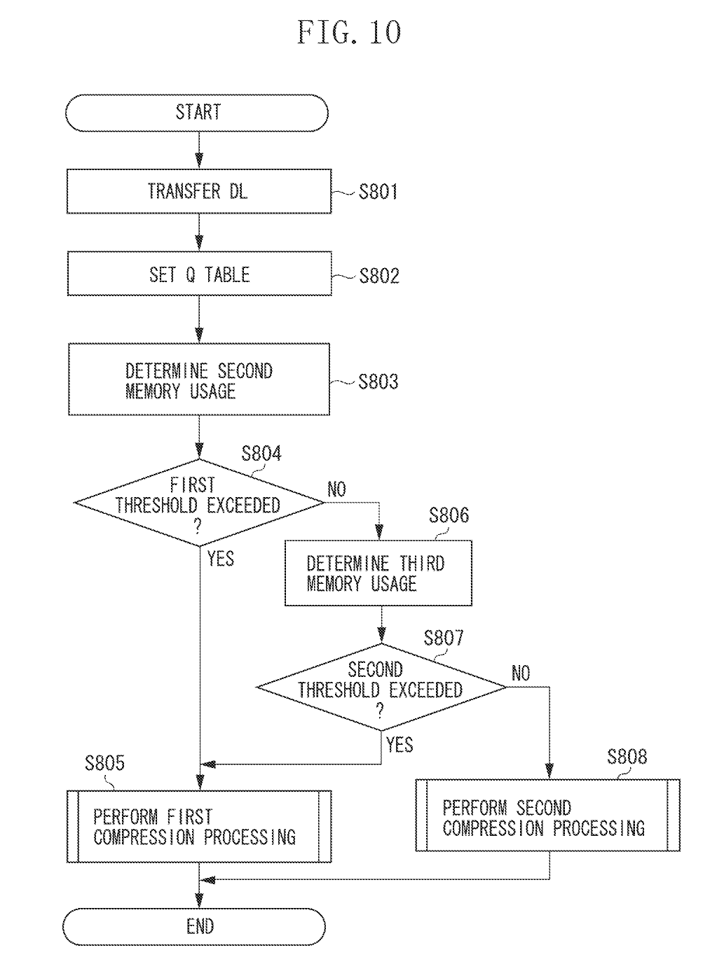

FIG. 10 is a flowchart illustrating a control procedure of the image processing apparatus according to the exemplary embodiment. The processing is a fallback processing, and corresponds to the detailed procedure of step 5305 illustrated in FIG. 3. Each step is implemented by the CPU 105 loading a control program in the memory 106.

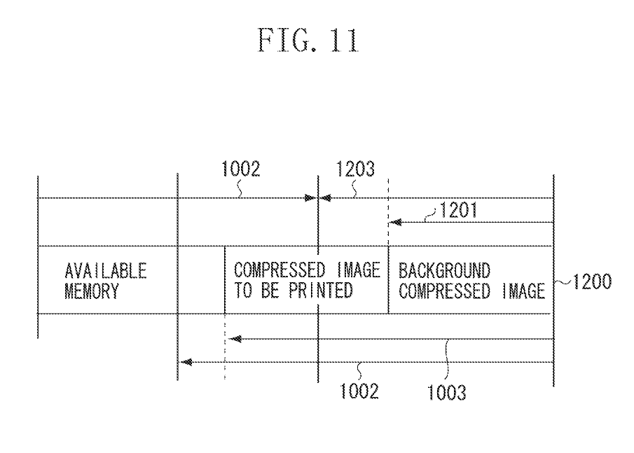

When the above-described processing in step S305 illustrated in FIG. 3 is carried out, the processing starts. In step S303, the CPU 105 transfers the DL generated in the memory 106 to the local memory in the rendering unit 251 (S801). In step S802, the CPU 105 sets the Q table corresponding to the Q-table ID set to the variable current QID, to the compression unit 252. In step S803, the CPU 105 determines the memory usage status. FIG. 11 illustrates the usage of a third memory in the memory 106 illustrated in FIG. 1. The present exemplary embodiment is incorporated also in a fourth exemplary embodiment described below. In FIG. 11, reference numeral 1202 denotes an amount of a first threshold.

In step S804, if the CPU 105 determines that an amount 1201 of the background image in the fallback is greater than a difference 1203 between an amount of the whole memory sufficient for storing the raster image information and the amount of the first threshold (YES in step S804), the processing proceeds to step S805. In step S805, the CPU 105 performs the first compression processing.

In step S804, if the CPU 105 determines that the amount 1201 of the background image in the fallback is equal to or less than the difference 1203 between the amount of the whole memory sufficient for storing the raster image information and the amount of the first threshold (NO in step S804), the processing proceeds to step S806. In step S806, the CPU 105 determines the memory usage status.

In step S807, the CPU 105 determines whether the sum of the amount of the compressed image waiting for printing and the amount of the background compressed image in the fallback is greater than the amount of a second threshold 1204. In step S807, if the CPU 105 determines that the sum of the amount of the compressed image waiting for printing and the amount of the background compressed image in the fallback is greater than the amount of the second threshold 1204 (YES in step S807), the processing proceeds to step S805. In step S805, the CPU 105 performs the first compression processing.

In step S807, if the CPU 105 determines that the sum of the amount of the compressed image waiting for printing and the amount of the background compressed image in the fallback is equal to or less than the amount of the second threshold 1204 (NO in step S807), the processing proceeds to step S808. In step S808, the CPU 105 performs the second compression processing. In the first compression processing and the second compression processing, the DL generated in the memory 106 is converted into a compressed image, and the fallback processing ends. In the image processing apparatus in the third exemplary embodiment, by dealing similarly with the amount of the compressed image waiting for printing expected to immediately become available, as the available memory, the memory usage status can be determined more appropriately. Thus, in the case where waiting for available memory is likely to occur, the fake compression processing is performed. Accordingly, even if the compression ratio is high, the compression processing time after the memory which is waited for becomes available, can be reduced to the minimum. In the case where waiting for the available memory is not likely to occur, the unnecessary fake compression can be skipped. Accordingly, the compression processing time can be reduced.

Hereinafter, the fourth exemplary embodiment is described. In the image processing apparatus described in the third exemplary embodiment, if in the printer, output cannot be carried out, for example, due to absence of paper or paper jam, the compressed image waiting for printing is not immediately erased, and a state in which an available memory space is not obtained as expected, continues.

By checking the status of the printer, the above-described problem can be solved. The description in the exemplary embodiment is similar to that in FIG. 3 in the above-described first exemplary embodiment. Accordingly, only different parts will be described below. Specifically, the CPU 105 serves as a first determination unit, a second determination unit, a first control unit, and a second control unit. More specifically, the CPU 105 serves as the first determination unit for determining whether a data amount of the background compressed data exceeds an amount of a difference between an amount of space securable in the memory 106 and a first threshold determined from the amount of the memory available in the memory 106. Similarly, the CPU 105 serves as the second determination unit for determining whether a data amount of the sum of the background compressed data and the compressed data waiting for printing exceeds a second threshold determined from the memory amount available in the memory 106.

If the CPU 105 determines that the printer 103 can output the image data onto recording paper, the CPU 105 makes the following determination. The CPU 105 determines whether the data amount of the background compressed data exceeds the amount of the difference between the amount of space securable in the memory 106 and the first threshold determined from the amount of the memory available in the memory 106. If the CPU 105 determines that the data amount does not exceed the amount of the difference from the first threshold (if the CPU 105 determines NO in step S910 described below), the CPU 105 further performs the following determination.

Namely, the CPU 105 determines whether the data amount of the sum of the background compressed data and the compressed data waiting for printing exceeds the second threshold determined from the memory amount available in the memory 106. If the CPU 105 determines that the amount of the data exceeds the second threshold (YES in step S913), the CPU 105 performs the fake compression processing for compressing the image data with the compression unit 252 in step S911 described below without storing the background compressed data in the memory 106.

If the CPU 105 determines that the printer 103 can output the image data on the recording paper, and the amount of the data does not exceed the second threshold (NO in step S913), the CPU 105 performs the following processing. The CPU 105 stores the background compressed data in the memory 106 without performing the fake compression processing with the compression unit 252. This processing is performed by the CPU 105 if the CPU 105 determines NO in both of steps S909 and S913 described below.

On the other hand, if the CPU 105 determines that the printer 103 cannot output the image data on the recording paper, the CPU 105 further performs the following determination. Namely, the CPU 105 determines whether the data amount of the sum of the background compressed data and the compressed data waiting for printing exceeds the second threshold determined from the memory amount available in the memory 106. If the CPU 105 determines that the amount of the data exceeds the second threshold (YES in step S906), the CPU 105 performs the fake compression processing for compressing the image data with the compression unit 252 in step S907 described below.

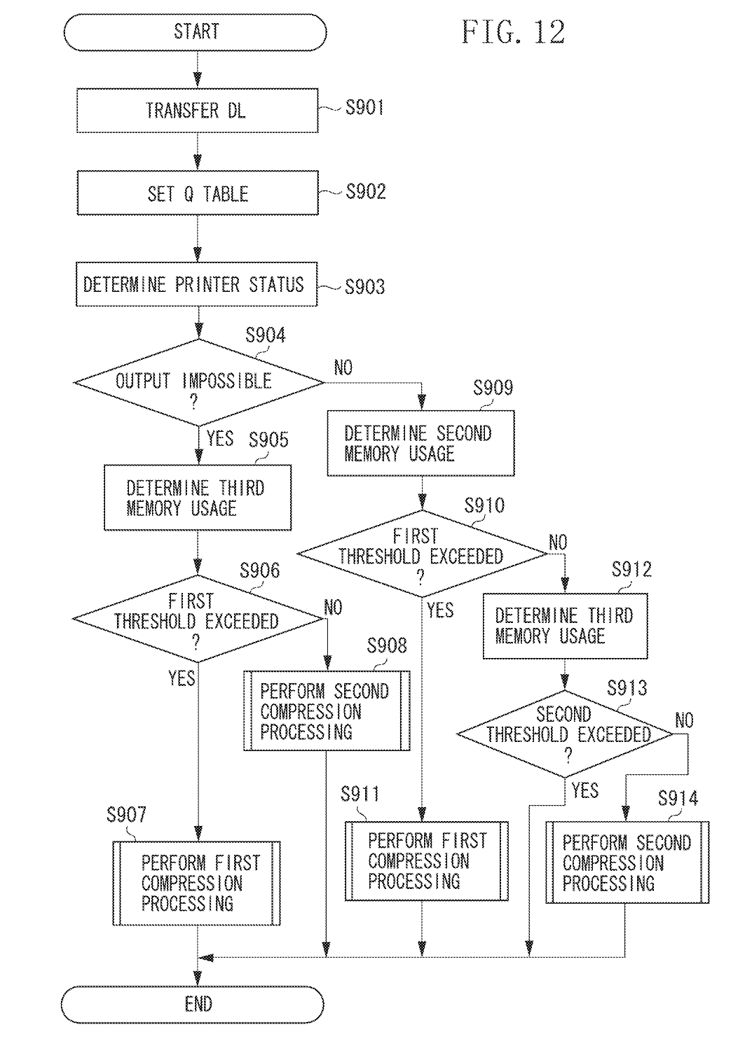

If the CPU 105 determines that the data amount of the sum of the background compressed data and the compressed data waiting for printing does not exceed the second threshold (NO in step S906), the CPU 908 performs step S908 described below. Namely, the CPU 105 stores the background compressed data in the memory 106 without performing the fake compression processing with the compression unit 252. Hereinafter, each processing is described with reference to FIG. 12. The second threshold is illustrated in FIG. 11. The first threshold is illustrated in FIG. 9.

FIG. 12 is a flowchart illustrating a control procedure of the image processing apparatus according to the exemplary embodiment. The processing is a fallback processing, and corresponds to the detailed procedure of step S305 illustrated in FIG. 3. Each step is implemented by the CPU 105 loading a control program in the memory 106.

When the processing in step S305 illustrated in FIG. 3, in step S303 is carried out, the CPU 105 transfers the DL generated in the memory 106 to the local memory in the rendering unit 251 (step S901). Then, the processing proceeds to step S902. In step S902, the CPU 105 sets the Q table corresponding to the Q-table ID set to the variable current QID, to the compression unit 252.

In step S903, the CPU 105 determines the status of the printer. In step S904, the CPU 105 determines whether the printer 103 cannot perform output due to, for example, absence of paper or paper jam. In step S904, if the CPU 105 determines that the printer 103 cannot perform output due to, for example, absence of paper or paper jam (YES in step S904), the processing proceeds to step S905. Steps after this step are similar to those in step S806 and after step S806 illustrated in FIG. 10 in the third exemplary embodiment. Accordingly, their descriptions are omitted. In step S904, if the CPU 105 determines that the printer 904 can perform output without, for example, absence of paper or paper jam (NO in step S904), the processing proceeds to step S909. Steps after this step are similar to those in step S803 and after step S803 illustrated in FIG. 10 in the third exemplary embodiment. Accordingly, their descriptions are omitted.

In the image processing apparatus described in the fourth exemplary embodiment, by checking the status of the printer, whether the compressed image waiting for printing is to be immediately erased can be determined. Accordingly, the memory usage status can be determined more appropriately. Thus, in the case where waiting for available memory is likely to occur, the fake compression processing is performed. Accordingly, even if the compression ratio is high, the compression processing time after the waiting for the available memory is finished can be reduced to the minimum. In the case where the waiting for the available memory is not likely to occur, the unnecessary fake compression can be skipped. Accordingly, the compression processing time can be reduced.

With the exemplary embodiments described in detail to which the present invention can be applied, even if the types of data used in application are different from each other, at the time of installation, transfer can be carried out by deleting unnecessary data using the data definition file.

Each step in the exemplary embodiments of the present invention can be implemented by executing software (program of computer executable instructions) acquired via a network or various storage medium(s) using a processing device (CPU or micro-processor (MPU)) in a personal computer (computer), or the like. A suitable storage medium may be, for example, a non-transitory computer-readable storage medium, such as one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. It is to be understood that the invention is not limited to the above-described exemplary embodiments, and various modifications (including organic combinations of the exemplary embodiments) can be made without departing from the scope of the invention.

According to the exemplary embodiments of the present invention, in performing the fallback processing within the limited amount of the memory, if the available memory is insufficient, by utilizing the time waiting for space in the memory, the fake compression processing is performed. Accordingly, the compression processing time after the memory which is waited for becomes available can be reduced to the minimum even if the compression ratio is high. Further, in performing the fallback processing within the limited amount of the memory, if the available memory is sufficient, the unnecessary fake compression processing can be skipped, and the compression processing time can be reduced.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-214782 filed Sep. 27, 2010, which is hereby incorporated by reference herein in its entirety.

What is claimed is:

1. An image processing apparatus comprising:
a generation unit configured to generate image data from drawing information;
a compression unit configured to compress the image data;
a storage unit configured to store the drawing information, the image data, and background compressed data generated by the compression unit compressing the image data as drawing information;
a determination unit configured to determine whether a data amount of the image data or a data amount of the background compressed data exceeds an amount of a difference between an amount of space securable in the storage unit and a first threshold determined from the amount of the memory available in the storage unit; and
a control unit configured to perform control such that if the determination unit determines that the amount of the image data exceeds the amount of the difference from the first threshold, without storing the image data in the storage unit, a fake compression processing for compressing the image data is performed by the compression unit, and if the determination unit determines that the amount of the image data does not exceed the amount of the difference from the first threshold, a compression processing for compressing the image data is performed by the compression unit.

2. An image processing apparatus comprising:
a generation unit configured to generate image data from drawing information;
a compression unit configured to compress the image data;
a storage unit configured to store the drawing information, compressed data waiting for printing generated by the compression unit compressing the image data, and background compressed data generated by the compression unit compressing the image data as drawing information;
a first determination unit configured to determine whether a data amount of the background compressed data exceeds an amount of a difference between an amount of space securable in the storage unit and a first threshold determined from the amount of the memory available in the storage unit;
a second determination unit configured to determine whether a data amount of the sum of the background compressed data and the compressed data waiting for printing exceeds a second threshold determined from the amount of the memory available in the storage unit; and
a control unit configured to perform control such that if the first determination unit determines that the amount of the background compressed data exceeds the amount of the difference, or if the first determination unit determines that the amount of the background compressed data does not exceed the amount of the difference, and the second determination unit determines that the data amount of the sum of the background compressed data and the compressed data waiting for printing exceeds the second threshold, without storing the image data in the storage unit, the fake compression for compressing the image data is performed by the compression unit, and if the first determination unit determines that the amount of the background compressed data does not exceed the amount of the difference, and if the second determination unit determines that the data amount of the sum of the background compressed data and the compressed data waiting for printing does not exceed the second threshold, the compression for compressing the image data is performed by the compression unit.

3. A data processing method for an image processing apparatus including a generation unit configured to generate image data from drawing information, a compression unit configured to compress the image data, and a storage unit configured to store the drawing information, the image data, and background compressed data generated by the compression unit compressing the image data as drawing information, the data processing method comprising:
determining whether a data amount of the image data or a data amount of the background compressed data exceeds an amount of a difference between an amount of space securable in the storage unit and a first threshold determined from the amount of the memory available in the storage unit;
performing a fake compression processing for compressing the image data with the compression unit without storing the image data in the storage unit if it is determined in the determination that the amount of the image data exceeds the amount of the difference from the first threshold; and
performing a compression processing for compressing the image data with the compression unit if it is determined in the determination that the amount of the image data does not exceed the amount of the difference from the first threshold.

4. A storage medium storing a program executable in a computer having a generation unit configured to generate image data from drawing information, a compression unit configured to compress the image data, and a storage unit configured to store the drawing information, the image data, and background compressed data generated by the compression unit compressing the image data as drawing information, the program comprising:
determining whether a data amount of the image data exceeds an amount of a difference between an amount of space securable in the storage unit and a first threshold determined from the amount of the memory available in the storage unit;
performing a fake compression processing for compressing the image data with the compression unit without storing the image data in the storage unit if it is determined in the determination that the amount of the image data exceeds the amount of the difference from the first threshold; and
performing a compression processing for compressing the image data with the compression unit if it is determined in the determination that the amount of the image data does not exceed the amount of the difference from the first threshold.
